(19) United States
(12) Patent Application Publication
(10) Pub. No.: US 2024/0378287 A1
(43) Pub. Date: Nov. 14, 2024

(54) ENDPOINT DETECTION AND RESPONSE TO CYBERSECURITY THREATS

(71) Applicant: Field Effect Software Inc., Ottawa (CA)

(72) Inventor: Matthew HOLLAND, OTTAWA (CA)

(73) Assignee: Field Effect Software Inc., Ottawa, ON (CA)

(21) Appl. No.: 18/286,099

(22) PCT Filed: Apr. 7, 2022
(86) PCT No.: PCT/CA2022/050534

§ 371 Date: Oct. 6, 2023

Related U.S. Application Data
(60) Provisional application No. 63/173,033, filed on Apr. 9, 2021.

(51) Int. Cl. G06F 21/55

(52) U.S. Cl. CPC G06F 21/554; G06F 2221/033

(57) ABSTRACT

Controlling code execution on a computing device may prevent malicious code from executing. In order to control code execution, context information for code packages on the computing device can be maintained. The context information may be generated upon initialization of the computing device or if changes to the code package are made. The context information may be used in conjunction with access control lists (ACLs) and/or execution control lists (ECLs) in order to quickly evaluate whether a code package should be allowed to execute.

### RELATED APPLICATIONS

This application claims the benefit of priority to U.S. provisional patent application Ser. No. 63/173,033, the entire contents of which is hereby incorporated by reference.

### TECHNICAL FIELD

The current disclosure relates to cybersecurity and, in particular, to functionality for detecting and responding to cybersecurity threats on an endpoint.

### BACKGROUND

Cybersecurity attempts to prevent or mitigate computer related security threats. The threats may take various forms such as viruses, malware, ransomware, etc. Security threats typically include the execution of malicious code. While not all threats may involve the execution of malicious code, detecting and possibly preventing the execution of malicious code may nonetheless prevent or mitigate a portion of security threats.

Approaches to preventing execution of malicious code may include determining signatures of processes to determine if they match signatures associated with known malicious processes. While these approaches may be useful in detecting some security threats they may be difficult to maintain signatures on all endpoints for new threats. Additionally, having to evaluate a process each time an action occurs can be computationally expensive for endpoints.

An alternative, additional and or improved process for detecting and possibly responding to cybersecurity threats is desirable.

### BRIEF DESCRIPTION OF THE DRAWINGS

Further features and advantages of the present disclosure will become apparent from the following detailed description, taken in combination with the appended drawings, in which:

FIG. 1 depicts an endpoint system for mitigating security threats;

FIG. 2 depicts an endpoint method for mitigating security threats;

FIG. 3 depicts details of a concurrent state monitor;

FIG. 4 depicts details of access/execution control;

FIG. 5 depicts a policy structure;

FIG. 6 depicts an illustrative ACL/ECL relationship; and

FIG. 7 depicts an illustrative policy.

### DETAILED DESCRIPTION

In accordance with the present disclosure there is provided a method for securing and controlling code execution, within an operating system (OS) of a computing device, the method implemented at the computing device and comprising: maintaining context information for code packages on the computing device: determining and storing context information of code packages on the computing device, for each of the code packages the context information comprising information on a state of the respective code package and one or more attributes of the respective code package; and monitoring code packages executing on the computing device for changes to the context information and updating the stored context information with any changes to the context information; independent of maintaining the context information: receiving notification of an OS event associated with an accessor code package; attempting to match the OS event to an access control list (ACL) or execution control list (ECL) specifying at least one entry, each entry comprising an OS event and associated event context defining a validation condition, and if a match occurs: retrieving context information associated with the accessor code package; validating the retrieved context information against the event context specified in the matched ACL/ECL entry; and performing an action specified in the matched ACL/ECL list entry upon validation of the retrieved context information.

In accordance with a further embodiment of the method, the ACL defines one or more conditions for accessing a resource by the accessor code package and the ECL defines one or more conditions for executing the accessor code package.

In accordance with a further embodiment of the method, the ACL/ECL comprises at least one of: a process execution control list; a process access control list; a heuristics access control list; a module execution control list; a removable drive access control list; a file read/write access control list; and a registry access control list.

In accordance with a further embodiment of the method, the action associated with the matched control list entry comprises at least one of: blocking access of the OS event; allowing access of the OS event; notifying a location of the access of the OS event; blocking execution of the OS event; allowing execution of the OS event; notifying a location of the execution of the OS event; suspending a process of the OS event; and blocking the process of the OS event.

In accordance with a further embodiment of the method, the ACL/ECL comprises a plurality of ACLs or ECLs.

In accordance with a further embodiment of the method, the ACL/ECL is defined in a policy structure, the policy structure defining: one or more ACL/ECLs; and policy information specifying an action to be performed based on the validated one or more ACLs/ECLs of the policy structure.

In accordance with a further embodiment of the method, the policy structure further comprises an indication of a relationship between ACLs/ECLs of the policy structure.

In accordance with a further embodiment of the method, the method further comprises: receiving one or more additional ACLs/ECLs to add to the policy structure; and combining the one or more additional ACLs/ECLs with the plurality of control lists of the policy structure.

In accordance with a further embodiment of the method, the one or more ACLs/ECLs are specified in one or more policy structures.

In accordance with a further embodiment of the method, the method further comprises: receiving an indication of one or more ACLs/ECLs to remove from the policy structure; and removing the indicated one or more ACLs/ECLs from the policy structure.

In accordance with a further embodiment of the method, the context information includes an indication whether or not a process binary is signed.

In accordance with a further embodiment of the method, the code packages comprise one or more of: processes; dynamic libraries; and drivers.

In accordance with the present disclosure there is further provided a computing device comprising: a processor for executing instructions; and a memory storing instructions which when executed by the processer configure the computing device to perform a method as described above.

In accordance with the present disclosure there is further non-transitory computer readable medium storing instructions which when executed by a processer of a computing device configure the computing device to perform method as described above.

Endpoints may comprise computing devices including for example personal computers, laptops, servers, mobile computing devices, etc. As described further below, endpoint protection against different threats is provided by using a set of access control lists (ACLs) and execution control lists (ECLs). Endpoint detect and respond (EDR) functionality runs on each of the endpoints and can monitor the endpoint to maintain context information about code packages on a host. The code packages provide packages of code that may be loaded and executed and may include, for example, processes, dynamic libraries, drivers, etc. The context information allows determining information for the code package once, for example at boot time of the endpoint, and used multiple times when evaluating whether are certain action should be allowed, blocked or some other action taken. The determination of whether or not to take a certain action may be defined using ACLs/ECLs which may be provided as one or more policy structures. The policy structures allow operators to easily define threats and automatically take action. The policy structures can be easily distributed to endpoints and used in evaluating operating system events using the context information.

The EDR functionality provides a set of automated active detection and blocking features that utilize a specialized set of ACLs and ECLs that are designed to allow operators to easily define threats and automatically take action. The EDR system is based on real-time observation, and utilizes simplicity over complexity. While there are many advantages to this approach, including that the ACLs/ECLs are structured to be simple and mirror how actual threats are detailed and tracked. Further the ACLs/ECLs enable quick decision making without the need of complex event correlation. ACLs/ECLs are conceptually aligned with malware “pinch points”, and allow threats to be quickly identified and crippled without complexity. ACLs/ECLs can be used to identify and track threats of all types, ranging from ransomware to standard malware to complex advanced persistent threat (APT) techniques. ACLs/ECLs can also be used to block or notify based on violations of the ACLs/ECLs, and trigger subsequent termination or suspension of processes, threads, drivers, dynamic libraries, etc. and threats.

The EDR functionality may use a state machine to maintain a parallel set of pre-defined conclusions about code packages on a host. For example, the state of whether a code package binary is signed, cached and maintained for the duration of a host boot or until that binary changes. Maintaining the context information enables a pattern of decide-once, act-many which pushes expensive processing to only be performed a single time per boot of the host. This avoids the need to process ranges of events in complex manners, which can often lead to heavy processing or unexpected results. Ongoing operating system object/activity sensors may be used to maintain the state machine of code packages and attributes about those code packages. The object/activity sensors may be powered by security oriented APIs on Windows and macOS (i.e. APIs intended for security tracking).

In addition to maintaining the state of code packages and attributes, the EDR functionality also processes OS events against one or more ACLs/ECLs and can block, allow, or take other actions on the OS events. One or more ACLs/ECLs can be defined in one or more policy objects. The policy object may be used to define various ACL/ECL configurations as policies that match intuitively to operational constructs such as anti-ransomware; malware data collection; malware persistence vectors; Microsoft office usage; Libre Office usage; accountant software access; legal software access; medical software access; standard Windows workstation heuristic protection; standard Windows Server heuristic protection, etc.

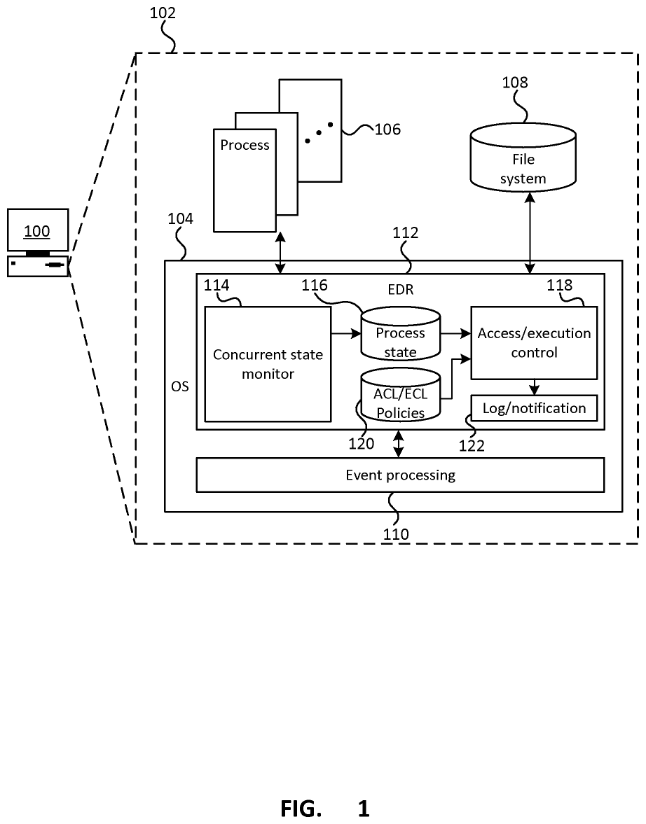

FIG. 1 depicts an endpoint system for mitigating security threats. The system is depicted as a computer 100, although the EDR functionality may be provided on other endpoint devices. Although not depicted in FIG. 1, the endpoint computer 100 comprises one or more processors that execute instructions and a memory that stores instructions and data. The instructions stored in memory, when executed by the processor configure the endpoint computer to provide various functionality 102. The functionality 102 includes an operating system 104 that provides the functionality to execute processes 106. The processes 106 may have various attributes associated with them, such as where the process originated from, whether it is signed, etc. The processes can perform a variety of functionality, including for example accessing a file system 108. Although depicted in FIG. 1 as processes, it is possible that the packages of executable code comprise processes, threads, dynamic, libraries, drivers, kernel drivers, etc.

The OS functionality 104 may have event processing functionality 110 that processes events, such as executing processes, accessing files, controlling displays, etc. The OS functionality may also include EDR functionality 112. Although depicted as being provided as part of the operating system 104, the EDR functionality need not be part of the OS and may instead by executed on the OS like one of the processes 106.

The EDR functionality 112 may comprise a concurrent state monitor 114 that monitors the host and maintains information about processes or other executable code packages on the host. The concurrent state monitor 114 may use one or more OS object/activity sensors to maintain context information on the processes or code packages. The context information may be stored 116 in some structure such as a file, database, state machine or other structure. The context information comprises state information and attributes about the processes.

The state information may be used by access/execution control functionality 118. The access/execution control functionality 118 receives notifications of OS events and uses the state information along with one or more ACLs/ECLs, which may be stored in one or more policies 120. The access/execution control functionality matches the OS event to one or more ACLs/ECLs or policies specifying one or more ACLs/ECLs. If the OS event is matched to a policy or ACL/ECLs, the accessor process, or executable code package, associated with the event is validated according to the matched policy or ACLs/ECLs. As described further herein, the access/execution control functionality can validate the OS event based on a plurality of ACLs/ECLs which may be linked together in various relationships. Based on whether or not there was a violation in the validation of the ACL/ECL, the access/execution control 119 may take various actions including blocking the OS event, allowing the regular processing of the OS event to continue, or allowing the OS event but logging the event and/or sending a notification of the event to one or more locations. The EDR functionality 112 may include log/notification functionality 122 that may log events as well as provide notifications.

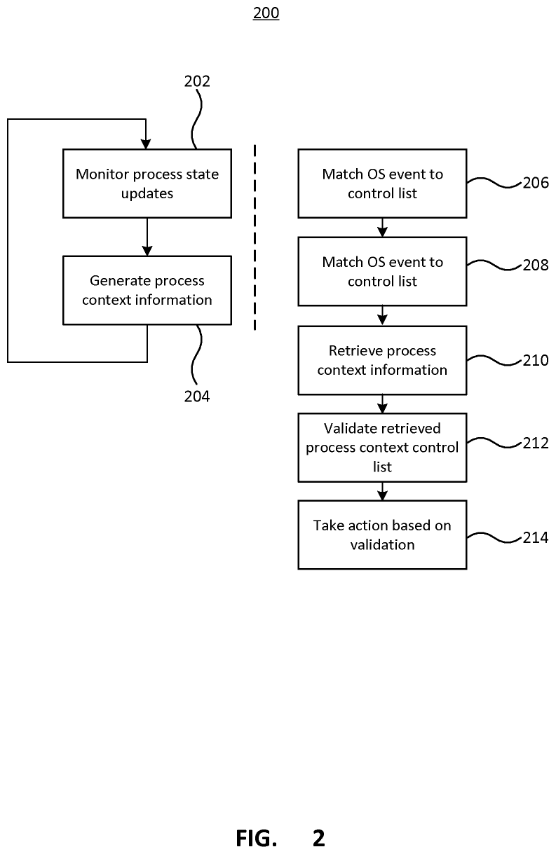

FIG. 2 depicts an endpoint method for mitigating security threats. The method 200 includes a first process that monitors process state updates (202) and generates context information (204) in order to maintain a state machine of the state and attributes of the code packages present on the host. Although depicted as monitoring process state updates, it may also occur during boot in order to generate the state information initially at boot. The monitoring may be done continuously in order to update the context information if any changes to the process or executable code packages occur.

Concurrent with the maintaining of the context information as described above, the method 200 may receive an OS event (206). The OS event may then be matched to one or more control lists (208), which may be for example one or more ACLs/ECLs specified in a policy. If the OS event matches a control list, the context information for the accessor process of the OS event may be retrieved (210) and used to validate the accessor process against the matched control list(s) (212). Based on the validation, actions can be taken for the OS event (214). The actions, may include, for example allowing the OS event to be processed as normal, blocking the OS event from further processing, killing or suspending the processes associated with the OS event, as well as logging or sending a notification of the OS event.

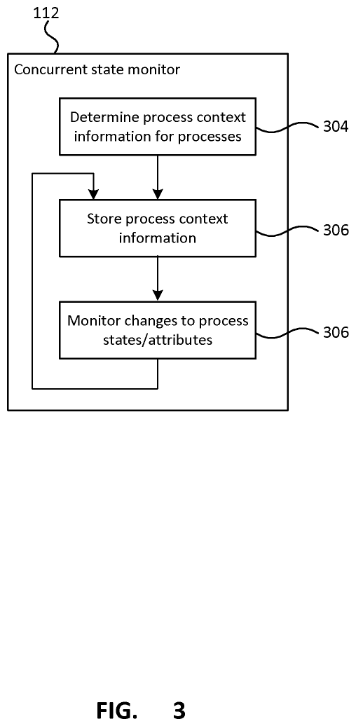

FIG. 3 depicts details of a concurrent state monitor. The concurrent state monitor 112 may for example determine context information for processes or code packages (304), which may be done initially for a plurality of processes/code packages. For example, during a boot process of the host, the context information for the various processes or code packages on the host can be determined. The determined context information is stored (306) and then the concurrent state monitor may monitor for changes to states and/or attributes of the code packages (308). If any changes to state and/or attributes are detected, or if new code packages are detected, the state information may be updated and stored (306).

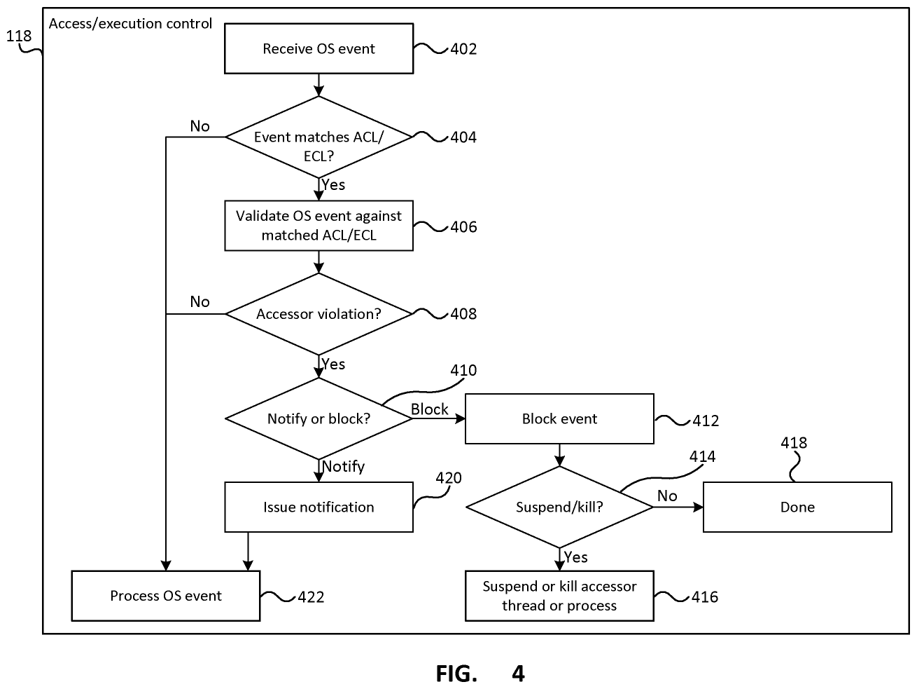

FIG. 4 depicts details of access/execution control. The access/execution control functionality 118 may receive an OS event (402). When an operating system event occurs, an ACL/ECL look-up occurs to determine if the event matches any ACLs/ECLs (404). If a matching entry exists (Yes at 404) it is evaluated to validate the OS event against the ACL/ECL (406), which may be done by processing the ACL/ECL entries and relationships, using context information. Validating the ACL/ECL may be done using the state machine to verify the state of the accessor process/code package. If the accessor violates the stipulations of the ACL/ECL, then a violation occurs (408). If a violation occurs (Yes at 408), a response action to the event is determined, which is depicted as being either to send a notification of the violation or to block the event (410). If the accessor should be blocked as a result of the violation (Block at 410), the event is blocked (412). Although not depicted in FIG. 4, a notification and/or log may be generated upon blocking an event. After blocking an event, it may be determined whether the accessor process, or executing code package, should be suspended or killed (414). If the executing code package should be suspended or killed (Yes at 414) the accessor is suspended or killed (416). If the executing code package should not be suspended or killed (No at 414), the processing is complete (418). Returning to notifying or blocking the OS event (410), if the violation should be notified (Notify at 410) a notification is issued (420), and/or the violation logged, and the processing of the OS event (422) continues. Similarly, the OS event processing (422) continues if the OS event does not match any ACLs/ECLs (No at 404) or if there is no violation of the ACLs/ECLs (No at 408).

As described above, the EDR functionality may be used to validate OS events against one or more ACL/ECLs. The control lists may be stored or otherwise specified in a policy object. The EDR functionality may include providing process change notifications and/or network state change notifications, which may use a push model, rather than a poll+diffs. Model. The EDR functionality may further provide session change notifications, which may use push triggers associated with log in/out events to do poll+diffs in order avoid time based polling, which can be very expensive for session changes. Although described with particular reference to process and network related OS events, it will be appreciated that the EDR functionality may be used with any OS events that may be generated.

As described further below, control lists may comprise a plurality of different types of control lists. The EDR functionality may comprise functionality for processing the different types of control lists. For example, the EDR functionality may functionality for handling process ECLs, which allows processes to be blocked from executing utilizing either allow-lists or block-lists. This is intended to provide a stop-gap mechanism to block specific executables from running. For example, a typical work station would likely never want to execute “reg.exe” or “regedit.exe”, or possibly a specific malware instance needs to be blocked as it was seen on another host on the network. Functionality for handling process ACLs allows process access relationships to be defined/controlled via allow-lists or block-lists. This is intended to stop attempts at things like process injection, or unexpected process space access. Functionality for handling heuristics ACLs allows platform-specific heuristics to be controlled via allow-lists or block-lists. This is intended to capture some more platform-specific behavior, such as various heuristics associated with process start-up mechanisms that are used to subvert detection. Functionality for handling module ECLs allows user mode/kernel mode modules to be blocked from being loaded into memory, utilizing either allow-lists or block-lists. This is intended to provide a mechanism to prevent things such as unsigned modules being loaded into specific processes, or malicious utilization of “rundll.exe” attempting to do malicious things. Network monitoring functionality allows network monitors to be placed to monitor IPv4/IPv6 and UDP/TCP traffic, integrating the message flow into the existing “network notification API” that currently exists in user mode. Functionality for handling removable drive ACLs allows removable drives to be blocked (or permitted) by serial numbers. It will also send notifications when drives have been blocked. Functionality for handling file read/write ACLs allows specific read/write ACLs to be placed on file types (based on file extension). It is intended to allow a security provider to learn about host networks (i.e. what programs are used to access content) in order to lock down file access to particular programs. This may be useful as a back-up to the ransomware protection, but it can also be used to identify malware heuristics. Functionality for handling registry ACLs allows ACLs to be placed on registry keys, values and key trees. It is intended to lock down the registry in particular locations to block the installation of persistent malware, and can also be used as a remote “AutoRuns” monitor to have an awareness as to when new auto-starting programs are added on the host. Although particular examples are used above for possible blocking conditions, it will be appreciated that other data may be used when determining whether to block certain events.

The EDR functionality may process OS events according to one or more matching control lists as described above. The control lists may include access control lists as well as execution control lists. The control lists may be specified within one or more policies. The policies may be provided by policy objects as described further below.

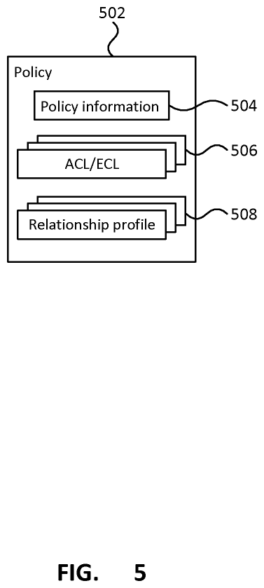

FIG. 5 depicts a policy object. The policy object 502 may comprise policy information 504, which may include policy information 504 such as policy name, ID, version information, as well as actions associated with possible violations, as well as policy flags. The policy object may also include one or more ACL/ECLs 506 as well as one or more relationships between the ACLs/ECLs 508.

The policy information may include, for example, a policy ID, which may be a 64-bit bit flag value that enable up to 64 policies to be defined and used across a customer set. Meaning to each flag may be predefined. Policies can be set or removed from the EDR functionality by citing multiple flags at a time, so compound update messages for updating the policies in force at an endpoint are possible which may help to reduce message traffic. Additionally, all ACL/ECL handling respects the concept of multiple policies, and as such combine/merge them as appropriate. The policy information may further include a policy version which may be a 64-bit value that identifies the version of the Policy as identified by the Policy ID. The policy information may further include. For example an indication of the policy platform, which may be a flag whose value indicates the platform on which the policy is compatible, intended to avoid bad outcomes from accidental policy deployment on the wrong platforms. The policy information may further include additional data such as a policy metadata flag whose value contains descriptive information about the intent of the policy. While such information may be largely informational, it may factor into the type of host-side notifications such as pop-ups, syslog, Windows Event Log, etc. that may be issued.

The policy object may include ACL/ECL information for one or more ACLs and/or ECLs. The ACLs and ECLs may include various different types, including, for example a process ECL, which provides execution control over process execution relationships, execution chains, etc. in order to define what processes can run and under what circumstances. A process ACL may provide access control in regards to processes accessing other processes, such as opening a handle with “write memory” permissions as a pre-cursor to process injection. Heuristic ACLs may provide control over platform-specific techniques, such as the Windows technique using NTFS transaction rollback to masquerade a process as being associated with another executable on disk. Modules ECLs may provide control over user mode and kernel module modules when they are mapped into process memory spaces. Registry ACLs may provide control over the access to registry keys, in particular to the writing of particular registry values, or the deletion of keys associated with system resources. File ACLs (Read and Write) may provide control over the reading/writing/renaming/deleting of files on disk, and associate expected application behavior to file types. Removable Drive ACLs may provide control over removable drives inserted into the host.

As mentioned above, the EDR policy construct may be implemented to facilitate combining policies on the end point agent and having them function well together. For example, consider a small example in which there is:
1. File Write ACL policy called “Microsoft Office” with an ID of 0x0000000000004000 indicates that the following file types can be accessed by <MSOFFICE_ROOT>\winword.exe:
   a. “.doc”
   b. “.docx”
   c. “.docm”
2. File Write ACL policy called “Libre Office” with an ID of 0x0000000010000000 indicates that the following file types can be accessed by <LIBREOFFICE_ROOT>\swriter.exe:
   a. “.doc”
   b. “.docx”
   c. “.doct”
   d. “.dot”

When both policies are applied to an endpoint agent, the File Write ACL listing would show the following combined policy data (note the bolded Policy ID values that combines the two Policy IDs from above):
0x0000000010004000—“.doc”
   <MSOFFICE_ROOT>\winword.exe
   <LIBREOFFICE_ROOT>\swriter.exe
0x0000000010004000—“.docx”
   <MSOFFICE_ROOT>\winword.exe
   <LIBREOFFICE_ROOT>\swriter.exe
0x0000000000004000—“.docm”
   <MSOFFICE_ROOT>\winword.exe
0x0000000010000000—“.doct”
   <LIBREOFFICE_ROOT>\swriter.exe
0x0000000010000000—“.dot”
   <LIBREOFFICE_ROOT>\swriter.exe

Depending on the type of policy, some policies are combined or kept separate. The crux of whether polices are combined or kept separate hinges on whether or not there is a data point around which to combine.

Combined policies may be overlapped based on the data they describe. For example, the above description of two File Write ACL policies have overlapping protection of common file types. When both policies are applied, their protection is combined such that both policies are applied around the same data pivot point, which in this case is the file extension. Combined policies are protected to the point where if they were exactly the same, and both were applied, and then one was removed, the one that was not removed remains in place. Of the policy types described above, the combined policies types include File ACLs, Registry ACLs and Removable Drive ACLs.

Separate polies are added side-by-side, even if they describe similar things. For example, if one Process ECL policy described a case where <WINDOWS>\System32\cmd.exe was blocked from running, and another Process ECL policy had additional restraints on <WINDOWS>\System32\cmd.exe, then both restraints would be active. Additionally, if one policy indicated to notify and was violated, and then another policy indicated to block an action, then the block action takes effect due to it having a higher system-impact, and any Process ECL logs issued will indicate both policies had a violation. This approach is required for entities that don't have a suitable data point around which combining could occur. Separate policies include Process ECLs, Process ACLs, Module ECLs and Heuristic ACLs.

Policies may be associated with different actions to be performed if a violation of the policy occurs. For example there may be three actions that can be assigned to policies, either notifying on violation, or blocking on violation, which may have different effects depending on the type of policy, and notifying when there is no confirmed match, or mismatch, which is referred to as a “unknown-list match”. For example, flags may be used to specify a desired action including:
NOTIFY_ON_VIOLATION—indicates that a log will be generated when a policy is explicitly violated, either in the form of a allow-list not being matched, or a block-list entry being specifically matched.
BLOCK_ON_VIOLATION—this flag indicates that an action will be specifically blocked when a policy is explicitly violated, either in the form of a allow-list not being matched, or a block-list entry being specifically matched. Additionally, a log will be generated that outlines the blocking event.
NOTIFY_ON_UNKNOWN-LISTUNKNOWN—this flag indicates that a log will be generated when a policy is a combination of both a allow-list and a block-list, and neither list is violated, which indicates the given event has fallen in a “unknown category”. Unknown-lists are discussed further in the next section.

A challenge with defining policies that describe what is allowed, and what is not allowed, to execute or perform actions on a host is that policy is always a definition of experience and what is known. However, there will always be weird or unexpected things that occur on customer networks/hosts, and the EDR policy solution is intended to make the most of what is known, and provision for what is not known. With that said, the following three ECL/ACL categories have been defined that describe what to do with matches or lack of matches:
Allow-lists—these lists outline the specific events that are permitted for a given ECL/ACL type.
Block-lists—these lists outline the specific events that are NOT permitted for a given ECL/ACL type.
Unknown-lists—this list, which isn't really a list, is a catch-all for cases where both allow-lists and block-lists are employed, but a given event matches neither.

Given the above definitions, there are four modes that can utilize these lists for some ECL/ACL types set forth below.
Allow-list Only—allow-lists define what is explicitly permitted, and anything that does not match is considered a policy violation.
Block-list Only—block-lists define what is explicitly not permitted, and anything that is matched is considered a policy violation. All non-matching events are permitted.
Allow-list + Block-list, Unknown-list Notifications Turned ON—allow-lists define what is explicitly permitted, block-lists define what is explicitly not permitted. If a allow-list match does not occur, and a block-list match does not occur, the action is permitted and a log is generated, marked as a unknown-list notification. This is intended to allow operators to track unknown-list violations to help learn about unexpected behavior without necessarily blocking host activity, especially if the ACL is marked to block on violation.
Allow-list + Block-list, Unknown-list Notifications Turned OFF—allow-lists define what is explicitly permitted, block-lists define what is explicitly not permitted. If a allow-list match does not occur, and a block-list match does not occur, the action is permitted.

As described above, policies may include various flags. The flags may be used through EDR for various purposes, including for example, to describe the fields and data types that are part of a given ECL/ACL object instance; to describe what actions should be taken when a policy violation occurs; to describe what fields and data types were violated per a policy violation. The flags may provide various different information for use in processing the ECL/ACLs. For example, flags may be included for a wide range of information such as name and/or locations of files, characteristics of entities of ECL/ACLs such as files, processes, modules, registry keys, etc. as well as actions to take.

EDR policies may leverage platform/software/user keywords in order to facilitate policies that do not know any information about the host on which they are being applied. For example, a Process ECL policy that describes the process c:\Windows\System32\cmd.exe would need to know which root drive Windows is installed on. In certain cases, it is c:, however it does not have to be. For that reason, the concept of keywords has been introduced such that this policy can be defined as <WINDOWS>\System32\cmd.exe and the <WINDOWS> keyword gets dynamically translated and replaced to the host specific value at run time, such as c:\Windows. This is only performed at key times during policy lifetimes to ensure there is not an associated performance hit with this approach.

The EDR endpoint agent functionality provides functionality to allow process blocking using a series of criteria, and optional levels of complexity in order to define simple or deep process execution relationships. Various keywords or placeholders may be used and replaced with the actual values on specific devices. For example, rules may be defined using keywords such as “<WINDOWS>”, “<PROGRAM_FILES>”, and “<OFFICE_ROOT>” which may be replaced with the actual paths on particular devices. Process execution is defined as individual entries which are at the highest level, block-list driven. Groups of block-listed process execution may be managed in Process ECL Policies, which may have the following high level structure:
Policy Flag + Version
+
Process ECL 1
Process ECL 2
Process ECL 3
. . .
Process ECL n

This object provides the ability to associate descriptive policy information with a group of Process ECLs, which travel as a single policy object. There are two categories of Process ECLs:
Child Process Driven may be used to define up to a certain number of levels, such as 7, deep of process execution, the type of Process ECL is evaluated at process create time and is intended to ascertain whether the creation chain is permitted to start the child process, intended to catch the abuse of processes. For example, this can be used to only permit powershell.exe to be used if it was started by explorer.exe. These can be quite complex if the need to verify that a process being executed is from a legitimate (non-malicious) execution chain.
Creator Process Driven may be used to define what a particular process can create in regards to child processes, intended to detect software being used to access beyond the original intentions of the author. For example, this can be used to limit what any process within the Microsoft Office installation directory can execute, such as only processes that reside within that same directory.

In addition to the above, all other ECLs/ACLs use Process ECLs as their data descriptors for identifying which process can/cannot access particular resources. For example, Registry ACLs have an object member that is a ProcessEclPolicyList that describes the processes that can/cannot access a particular registry key/value. The Process ECL object is important in the context of defining all ECLs/ACLs as part of EDR policies.

The interfaces associated with this new process blocking capability are as follows:
Add/Update Process ECL Policy—used to add new, or modify existing, Process ECL policies that are enforced by the agent. Policy overlap is handled gracefully by the agent, which is intended to allow for simple policy management.
   Input: ProcessEclPolicyList
   Output: None
Remove Process ECL Policy—remove an existing Process ECL policy from the agent.
   Input: PolicyRemove
   Output: None
List Process ECLs—list the Process ECLs that are currently enforced by the agent.
   Input: None
   Output: ProcessEclPolicyList
Flush Process ECL Logs—flushes any Process ECL logs that have been generated by Process ECL violations (notifications or blocking violations).
   Input: None
   Output: ProcessEclLogList

In addition to the Process ECL features, process notifications may be implemented in the EDR component for accurate process start/stop notifications, rather than a polling mechanism in User Mode that may be susceptible to missing short lived processes. These notifications may be populated in the EDR component and sent via a special message to the change notification layer.

Single instances of a Process ECL object describe a process instance and can be comprised of a single file string value (all string comparisons are case-insensitive), file hash value and series of signing state flags for specifying the process, possibly by its file name/location and or a hash value, and its state/attributes such as signed/unsigned, whether it is trusted or untrusted, whether the certificate has expired, etc. Process ECL objects can be linked via to other process ECLs via a parent or creator relationship.

If no specific process string is being specified, and no hash is being set, then the process string may be assumed to be, or set to, a value of “*” to indicate “all processes”. In this case, all processes will be checked against the specified signing flags.

Command line information can be very help for identifying additional execution conditions that describe a process execution intent. For example, rundll32.exe can be used to load and run arbitrary DLLs, and verifying those DLLs could be very useful. Another example would be verifying whether or powershell.exe is being executed with encoded content or not. To specify command line artifacts, one or more instances of a command line artifact object can be added to a process ECL object.

Utilizing Process ECLs to describe parent and creator process information allows policies to be built that can be quite specific to identify specific misuse of native processes (i.e. living off the land). It is important to note the difference/distinction between parent and creator processes. A creator process is the actual process that starts the new process. A parent process is the process that may or may not provide a set of handles to be inherited by the new process. Often, it is assumed that the parent is also the creator, but they can be different processes, and when evaluating which parent is deciding to start a new process, it is the creator process that should be evaluated (not the parent).

When a set of Process ECL objects are provided within a Process ECL Policy List, each Process ECL object may have a unique ID value, which should be unique within the context of the entire Process ECL Policy List. This value is used to correlate relationships between Process ECLs that are part of a flattened (on the wire) Process ECL Policy List, which can then be expanded vertically when in memory within the agent. These relationships are stored within the policy object. The relationship information may be provided as a relationship objects being associated within each process ECL at each level within the policy structure. The relationship information may have the following information about the relationships between Process ECL objects:
Process Record ID—identifies the unique ID of the process that has been created.
Parent Record ID—identifies the unique ID of the process that is parent to the newly created process.
Creator Record ID—identifies the unique ID of the process that is creator of the newly created process. This value is optional, however at least one of the Parent Record ID and the Creator Record ID should be specified, or both.

Consider the following example for which a match is desired for detection and blocking:
Target process—C:\Windows\System32\WindowsPowerShell\v1.0\powershell.exe
Creator process—must be a signed process
Parent process—cmd.exe
Creator of the parent process cmd.exe—must be a signed

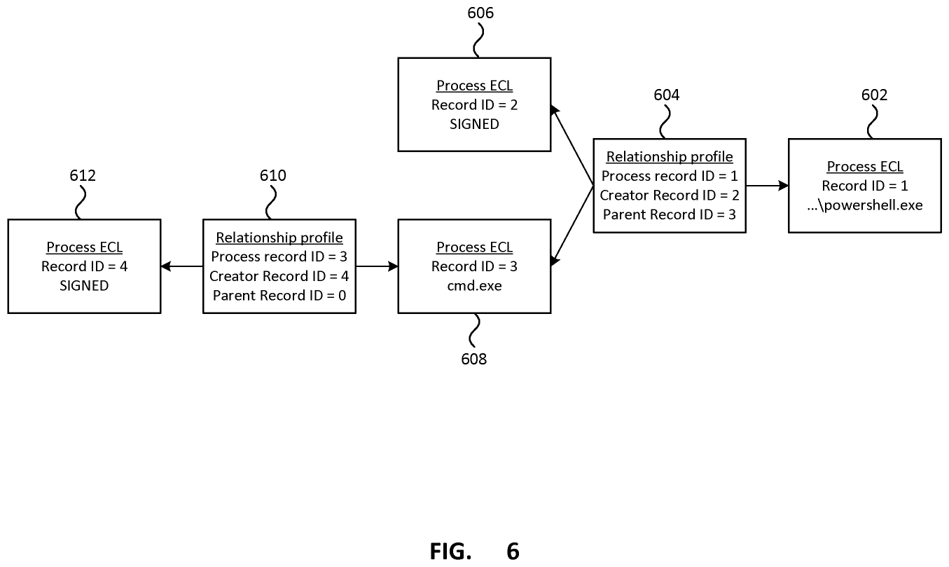

FIG. 6 depicts an illustrative ACL/ECL relationship. The relationship depicted in FIG. 6 is representative of the detection and blocking process described above. As depicted, the detection and blocking example requires the definition of four Process ECL objects 602, 606, 608, 612 and two Parent Process objects 604, 610 with the following values:
Process ECL 1 602
RecordId=1
Process String = “<WINDOWS>\System32\WindowsPowerShell\v1.0\powershell.exe”
Flags = BLOCK_ON_VIOLATION | FILE_PATH
Process ECL 3 606
RecordId=2
Process String = “*”
Flags = FILE_SIGNED
Process ECL 2 608
RecordId=3
Process String = “cmd.exe”
Flags = FILE_NAME
Process ECL 4 612
RecordId=4
Process String = “*”
Flags = FILE_SIGNED
Parent Profile 1 604
Process Record ID=1
Creator Record ID=2
Parent Record ID=3
Parent Profile 2 610
Process Record ID=3
Creator Record ID=4
Parent Record ID=0

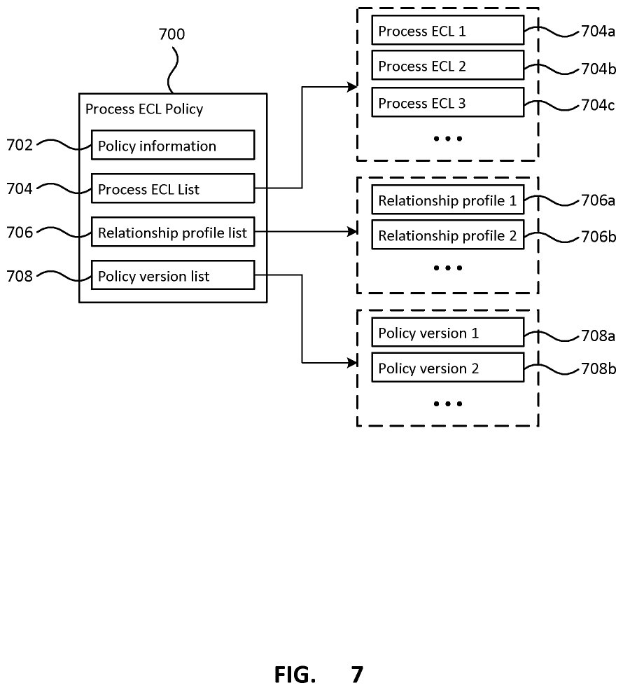

FIG. 7 depicts an illustrative policy object. The policy object 700 includes policy information 702, a process ECL list 704 comprising one or more process ECLs 704a, 704b, 704c. The policy object 700 may further include a relationship profile list 706 that comprises one or more relationships 706a, 706b between ECLs. The policy object may further include a policy version list 708, which comprises one or more policy versions 708a, 708b. Structures related to Process ECL management are the most complex aspect of EDR, largely because of the need to provide flexibility in the model to ensure real world threats can be modeled at a high level, or at a very specific level.

The policy object or structure may include one or more Process ECL policies, and is meant to travel as a single object. Instances of this structure can be applied to endpoint agents, containing either a single policy, some policies, or all Process ECL policies for the agent. The EDR endpoint is capable of processing it however may be desired. While this may appear to be complex, it is designed to facilitate structure optimization when it arrives within the endpoint's EDR management functionality, and facilitates the Process ECL structure set being completely reused to support the other ECL/ACL categories. This not only keeps a measure of consistency in the data model, but it also ensures a very rich level of descriptiveness across all of EDR. When Process ECLs are violated, logs may be generated and transferred to one or more locations such as a central server.

The above has described the details of a process ECL policy object. As described above, the EDR functionality may process different policy types. The structure of the various policy objects are similar to that of the process ECL policy object, however describe respective ACLs or ECLs for controlling execution or access to respective elements, such as modules, heuristics, file systems, registry, or removable drives.

The policy object structure for ACLs/ECLs provides a mechanism that allows both simple and complex relationships to be described, and so controlled by the EDR functionality. Policies can be added to and removed from the EDR functionality in order to maintain up-to-date protection at the end point. Further, the policy objects and ACLs/ECLs are simple to process at run time since required context information used in validating the ACLs/ECLs is maintained by a parallel process that evaluates processes to determine the state/attribute information once, which can then be re-used multiple times as ACL/ECL policies are validated.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope.

1. A method for securing and controlling code execution, within an operating system (OS) of a computing device, the method implemented at the computing device and comprising:
maintaining context information for code packages on the computing device:
determining and storing context information of code packages on the computing device, for each of the code packages the context information comprising information on a state of the respective code package and one or more attributes of the respective code package; and
monitoring code packages executing on the computing device for changes to the context information and updating the stored context information with any changes to the context information;
independent of maintaining the context information:
receiving notification of an OS event associated with an accessor code package;
attempting to match the OS event to an access control list (ACL) or execution control list (ECL) specifying at least one entry, each entry comprising an OS event and associated event context defining a validation condition, and if a match occurs:
retrieving context information associated with the accessor code package;
validating the retrieved context information against the event context specified in the matched ACL/ECL entry; and
performing an action specified in the matched ACL/ECL list entry upon validation of the retrieved context information.

2. The method of claim 1, wherein the ACL defines one or more conditions for accessing a resource by the accessor code package and the ECL defines one or more conditions for executing the accessor code package.

3. The method of claim 1, wherein the ACL/ECL comprises at least one of:
a process execution control list;
a process access control list;
a heuristics access control list;
a module execution control list;
a removable drive access control list;
a file read/write access control list; and
a registry access control list.

4. The method of claim 1, wherein the action associated with the matched control list entry comprises at least one of:
blocking access of the OS event;
allowing access of the OS event;
notifying a location of the access of the OS event;
blocking execution of the OS event;
allowing execution of the OS event;
notifying a location of the execution of the OS event;
suspending a process of the OS event; and
blocking the process of the OS event.

5. The method of claim 1, wherein the ACL/ECL comprises a plurality of ACLs or ECLs.

6. The method of claim 1, wherein the ACL/ECL is defined in a policy structure, the policy structure defining:
one or more ACL/ECLs; and
policy information specifying an action to be performed based on the validated one or more ACLs/ECLs of the policy structure.

7. The method of claim 6, wherein the policy structure further comprises an indication of a relationship between ACLs/ECLs of the policy structure.

8. The method of claim 6, further comprising:
receiving one or more additional ACLs/ECLs to add to the policy structure; and
combining the one or more additional ACLs/ECLs with the plurality of control lists of the policy structure.

9. The method of claim 8, wherein the one or more ACLs/ECLs are specified in one or more policy structures.

10. The method of claim 6, further comprising:
receiving an indication of one or more ACLs/ECLs to remove from the policy structure; and
removing the indicated one or more ACLs/ECLs from the policy structure.

11. The method of claim 1, wherein the context information includes an indication whether or not a process binary is signed.

12. The method of claim 1, wherein the code packages comprise one or more of:
processes;
dynamic libraries; and
drivers.

13. A computing device comprising:
a processor for executing instructions; and
a memory storing instructions which when executed by the processer configure the computing device to perform the method according to claim 1.

14. A non-transitory computer readable medium storing instructions which when executed by a processer of a computing device configure the computing device to perform the method according to claim 1.
